(19) United States
(12) Patent Application Publication
(10) Pub. No.: US 2014/0214678 A1
(43) Pub. Date: Jul. 31, 2014

(54) ONLINE PAYMENT

(71) Applicant: Cardlink Services Limited, Rhodes NSW (AU)

(72) Inventors: Richard Mark Williams, Rhodes NSW (AU); Keith Robert Goding Brown, Rhodes NSW (AU)

(73) Assignee: Cardlink Services Limited, Rhodes NSW (AU)

(21) Appl. No.: 14/230,320

(22) Filed: Mar. 31, 2014

Related U.S. Application Data
(63) Continuation of application No. PCT/AU2011/001269, filed on Sep. 30, 2011.

(51) Int. Cl. G06Q 20/38; G06Q 20/40

(52) U.S. Cl. CPC G06Q 20/385; G06Q 20/40
USPC 705/44

(57) ABSTRACT

The present disclosure relates to computing systems that support authorization of payments to online merchants. The computer receives from the merchant or a financial institution of the merchant (merchant FI) a payment request. The computer determines a customer FI and sends the payment request to the customer FI to cause the customer FI to send to the customer an authorization code. The computer then receives an authorization request associated with the payment having the authorization code as provided by the customer to the merchant. The computer determines the customer FI and sends the authorization request to the customer FI to cause the customer FI to verify the authorization code. In reply the computer receives from the customer FI an authorization confirmation for the payment and sends the authorization confirmation to the merchant or merchant FI.

### CROSS-REFERENCE TO RELATED APPLICATIONS

This application is a continuation of International Application No. PCT/AU2011/001269, filed on Sep. 30, 2011. The disclosure of the above application is incorporated herein by reference.

Incorporated here by reference is Australian provisional patent application No. 2011902123 entitled “Addresses in financial systems” filed on 31 May 2011.

Incorporated here by reference is PCT application also filed with the Australian Patent Office this day entitled “Transaction document storage” with Cardlink Services Limited also identified as the applicant.

Incorporated here by reference is PCT application also filed with the Australian Patent Office this day entitled “Payment requests” with Cardlink Services Limited also identified as the applicant.

### FIELD

The disclosure concerns computing systems of financial institutions and computing systems that interact and support functions of financial institutions, including payments to online merchants. The disclosure includes a description of methods, computer systems and software.

### BACKGROUND

The statements in this section merely provide background information related to the present disclosure and may not constitute prior art.

The popularity of the Internet has led to a large number of online merchants. Most online merchants will not provide any goods with an invoice in the hope that the customer pays the invoice after receiving the goods.

One method of online payment uses a credit card. The use of credit cards attracts costs for both the customer and merchant that is proportional to the payment amount.

To avoid these costs customers and merchants can arrange for transfer of funds between their savings or check accounts as held with their financial institution. However, funds transferred in this way are usually received one business day after the actual transfer instructions. Since a merchant will not provide the goods until the payment has been received in the merchant's account, the goods are also not provided until the following day. Many customers are attracted to the immediacy of an online purchase, for example to immediately receive the concert tickets or software download, and this delay makes this form of payment unattractive.

Any discussion of documents, acts, materials, devices, articles or the like which has been included in the present specification is solely for the purpose of providing a context for the present disclosure. It is not to be taken as an admission that any or all of these matters form part of the prior art base or were common general knowledge in the field relevant to the present disclosure as it existed in Australia before the priority date of each claim of this application.

### SUMMARY

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

In a first aspect there is provided a computer implemented method performed by a central financial management system for authorizing a payment for a purchase by a customer from a merchant, the method comprising:
(a) receiving from the merchant or a financial institution of the merchant (merchant FI) an input message including a payment request having:
   a customer identifier, and
   purchase information;
(b) based on the customer identifier, determining a financial institution of the customer (customer FI) and sending an output message including the payment request to the customer FI to cause the customer FI to send to the customer an authorization code that is associated with the payment;
(c) receiving from the merchant or the merchant FI an input message including an authorization request associated with the payment having the authorization code as provided by the customer to the merchant;
(d) determining the customer FI associated with the authorization request and sending an output message including the authorization request to the customer FI to cause the customer FI to verify the authorization code;
(e) receiving from the customer FI an input message including an authorization confirmation for the payment; and
(f) determining the merchant FI associated with the authorization confirmation and sending an output message including the authorization confirmation to the merchant FI.

It is an advantage that the method facilitates payments between two financial institutions, such as banks, without holding funds for the customer or the merchant. As a result, the customer and the merchant can use their existing financial accounts at their financial institutions and there is no need to open a new funds account with the central financial management system.

It is a further advantage that the payment can be made using accounts held at the customer FI and merchant FI without using credit cards issued by credit card payment brands, and therefore avoiding the costs associated with using such credit cards.

It is another advantage that unlike credit card payments, the customer is authenticated by providing a customer identifier, verification code and authentication code. The payment is authorized as quickly as a credit card payment but with reduced risk and no details of the underlying accounts held at the customer FI or merchant FI are disclosed to other parties in the transaction.

The central financial management system can authorize the payment to the merchant FI although the funds are transferred at a later time such as overnight. As a result, the payment between the two FIs using this method is confirmed within seconds and therefore much quicker than the transfer of funds between FIs can be confirmed.

As a result of all these advantages the present disclosure is able to increase online payment, enable financial institutions to offer valuable and function-rich electronic services to customers reinforcing the appeal of electronic banking to customers.

It is an advantage that the purchase information is sent to the customer FI and the customer FI can store this information for later use by the customer. For instance, the customer's FI may present a list of purchases to the customer and each item on that list has all the detail of the purchase similar to an invoice. The customer can access not only the name of the merchant and the payment amount, but also information about the purchased items, applied discounts or promotional material.

The purchase may be a purchase made from an online store of the merchant.

The payment request may include a merchant identifier and the method may further comprise determining from the merchant identifier the merchant FI. The merchant identifier may be a code that uniquely represents the merchant identifier or may simply be the merchant's name.

The payment request may further include a customer verification code associated with the customer identifier, and step (b) further comprises verifying the verification code by comparing the verification with the pre-stored verification code associated with the customer identifier. Alternatively, step (b) may further comprise sending the payment request to the customer FI to cause the customer FI to verify the verification code.

The method may be performed in real-time (for example 5 seconds), the purchase information may include the monetary value of the purchase.

The step (a) may further comprise storing in computer storage a persistent object to represent the payment transaction having an associated status and storing an indication that the status is pending, and (e) may further comprise updating the status by storing an indication that the status is authorized. The pending status in step (a) may be verification pending, and the method may further comprise in step (d) updating the status by storing an indication that the status is authorized.

Step (e) may further comprise storing in computer storage an indication that the payment can be settled, such as stored payments having a status of authorized, and

(f) determining whether an indication is stored that the payment can be settled and if so initiating the settlement between the customer FI and the merchant FI of the payment. Step (f) can be performed in real time (for example 5 seconds) leading to real time transfer of funds between the customer and the merchant.

Step (f) may further comprise initiating settlement of the multiple payments having an indication stored that the payment can be settled. It is an advantage of at least one form that the confirmation to the merchant FI that the payment has been authorized can be sent promptly, whereas actual payment (i.e. settlement) can take place in batches, say overnight.

Where the payment request is received from the merchant, the method may further comprise based on the merchant identifier of the payment request determining the merchant FI and sending the payment request to the merchant FI.

The purchase information may include information of the goods or services to be purchased.

Determining the customer FI may comprise using the customer identifier as a look up key in a computer storage that stores the customer FI associated with each of a plurality of customer identifiers.

Messages may be sent from or to a merchant using their payment gateway provider.

Sending the authorization code to the customer FI may cause the customer FI to determine whether the customer holds sufficient funds with the customer FI to make the payment.

The method may further comprise sending an output message including the authorization confirmation to the merchant.

The method may further comprise storing in computer storage associated with the payment request the determined customer FI and/or the merchant FI.

In a second aspect there is provided software, that is, computer readable instructions recorded on computer readable media, that when executed by a computer causes the computer to perform the method for authorizing a payment for a purchase by a customer from a merchant.

In a third aspect there is provided a computer system of a central financial management service provider for authorizing a payment for a purchase by a customer from a merchant, the system comprising:

one or more communications ports to send and receive messages; and

one or more processors to operate the communications port to
(a) receive from the merchant or a financial institution of the merchant (merchant FI) an input message including a payment request having:
a customer identifier, and
purchase information;
(b) based on the customer identifier, determine a financial institution of the customer (customer FI) and send an output message including the payment request to the customer FI to cause the customer FI to send to the customer an authorization code that is associated with the payment;
(c) receive from the merchant or the merchant FI an input message including an authorization request associated with the payment having the authorization code as provided by the customer to the merchant;
(d) determine the customer FI associated with the authorization request and send an output message including the authorization request to the customer FI to cause the customer FI to verify the authorization code;
(e) receive from the customer FI an input message including an authorization confirmation for the payment; and
(f) determine the merchant FI associated with the authorization confirmation and send an output message including the authorization confirmation to the merchant FI.

In a fourth aspect there is provided a computer system for controlling the authorization of a payment for a purchase by a customer from a merchant, the computer system comprising:

a persistence layer to store a status for the payment and user data including a user identifier and associated customer financial institution (FI);

a communication and mediation layer to receive an output message from a service layer, to send the output message to a recipient, to receive an input message from a sender, to validate the input message and to send the input message to the service layer; and

the service layer

to receive the input message from the communication and mediation layer,

where the input message includes a payment request, to determine a customer identifier, a merchant identifier and purchase information based on the payment request, to determine a customer FI based on the customer identifier and the user data in the persistence layer, to create the output message having the customer FI as recipient and including the payment request, that causes the customer FI to send to the customer an authorization code that is associated with the payment, to send the output message to the communication and mediation layer and to set the status in the persistence layer to waiting for authorization request,

where the status is waiting for authorization request and the input message includes a payment authorization request associated with the payment and having the authorization code as provided by the customer to the merchant, to determine the customer FI associated with the payment authorization request, to create the output message having the customer FI as recipient and including the authorization request, that causes the customer FI to verify the authorization code, to send the output message to the communication and mediation layer and to set the status in the persistence layer to waiting for authorization confirmation, and

where the status is waiting for authorization confirmation and the input message includes an authorization confirmation, to determine the merchant FI associated with the authorization confirmation, to create the output message having the merchant FI as recipient and including the authorization confirmation, and to send the output message to the communication and mediation layer.

In a fifth aspect there is provided a computer implemented method performed by a merchant or a financial institution of the merchant (merchant FI) for authorizing a payment for a purchase by a customer from the merchant, the method comprising:
(a) generating a payment request message having:
a customer identifier, and
purchase information;
(b) sending a message including the payment request to a central financial management system (CFMS) to cause the CFMS to send to a financial institution of the customer (customer FI) a message including the payment request;
(c) receiving from a customer an authorization code:
(d) generating an authorization request having the authorization code;
(e) sending a message including the authorization request to the CFMS to cause the CFMS to send to the customer FI a message including the authorization request;
(f) receiving from the CFMS a message including an authorization confirmation; and
(g) generating and sending to the customer a receipt for the payment.

In a sixth aspect there is provided a computer system of a merchant or a financial institution of the merchant (merchant FI) for authorizing a payment for a purchase by a customer from the merchant, the system comprising:

one or more communications ports to send and receive messages; and

one or more processors to operate the communications port to:
(a) generate a payment request message having:
a customer identifier, and
purchase information;
(b) send a message including the payment request to a central financial management system (CFMS) to cause the CFMS to send to a financial institution of the customer (customer FI) a message including the payment request;
(c) receive from a customer an authorization code,
(d) generate an authorization request having the authorization code;
(e) send a message including the authorization request to the CFMS to cause the CFMS to send to the customer FI a message including the authorization request;
(f) receive from the CFMS a message including an authorization confirmation; and
(g) generate and send to the customer a confirmation of successful payment.

In a seventh aspect there is provided software, that is, computer readable instructions recorded on computer readable media, that when executed by a computer causes the computer to perform the method according to the fifth aspect.

In an eighth aspect there is provided a computer implemented method performed by a financial institution of a customer for authorizing a payment for a purchase by the customer from a merchant, the method comprising:
(a) receiving a message including a payment request from a central financial service (CFMS) having:

a customer identifier, and

purchase information;
(b) verifying the payment request;
(c) sending to the customer an authorization code to cause the customer to send to the merchant the authorization code;
(d) receiving a message including an authorization request from a CFMS including a further authorization code,
(e) determining whether the authorization code matches the further authorization code by comparing the authorization code with the further authorization code, and if so
(f) sending a message including an authorization confirmation to the CFMS to cause the CFMS to send a message including the authorization confirmation to the merchant FI.

In a ninth aspect there is provided a computer system a merchant of a financial institution of the merchant (merchant FI) for authorizing a payment for a purchase by a customer from the merchant, the system comprising:

one or more communications ports to send and receive messages; and

one or more processors to operate the communications port to:
(a) receive a message including a payment request from a central financial service (CFMS) having:

a customer identifier, and

purchase information;
(b) verify the payment request;
(c) send to the customer an authorization code to cause the customer to send to the merchant the authorization code;
(d) receive a message including an authorization request from a CFMS including a further authorization code,
(e) determine whether the authorization code matches the further authorization code by comparing the authorization code with the further authorization code, and if so
(f) send a message including an authorization confirmation to the CFMS to cause the CFMS to send a message including the authorization confirmation to the merchant FI.

In a tenth aspect there is provided software, that is, computer readable instructions recorded on computer readable media, that when executed by a computer causes the computer to perform the method according to the eighth aspect.

Optional features of the first aspect set out above are also optional features of the other aspects where appropriate.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a financial grade information system used in this example to support the online purchase;

FIG. 2 illustrates the method of the first example for authorizing payment for a purchase by a customer from a merchant;

FIG. 3 illustrates as a flow diagram the steps performed by the CFMS in authorizing a payment;

FIG. 4 schematically shows the applications layers of the central financial management system (CFMS);

FIG. 5 schematically shows the state transitions of a state machine of the CFMS;

FIG. 6 illustrates a method for determining settlement details; and

FIG. 7 illustrates data on computer storage of the CFMS.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

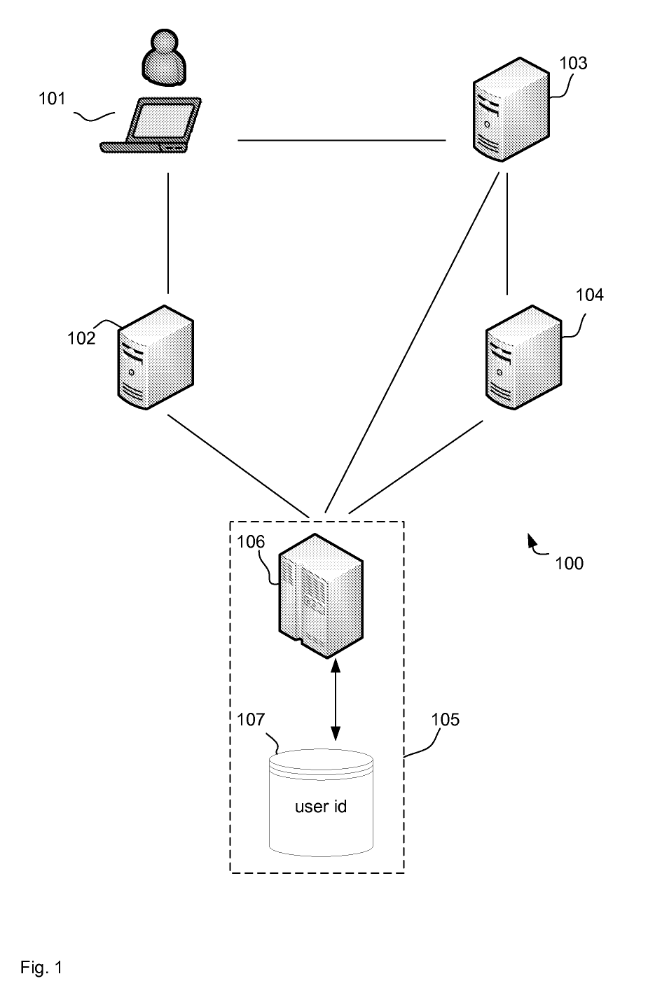

FIG. 1 illustrates a financial grade information system, such as an online payment system 100 comprising a customer 101 who has one or more accounts with a customer financial institution (FI) 102. The customer 101 using their computer interacts with a website of a merchant 103 to make a purchase from the merchant's online shop. The merchant 103 has one or more accounts with a merchant FI 104. The customer 103 wishes to pay for the purchase so that the merchant 103 initiates the shipment or allows the download of the purchased products. The payment will be made from customer's account at the customer FI 102 to the merchant's account at the merchant FI 104. The merchant can be any retailer, service provider or the like that receives payments from customers that holds an account with a FI. The customer can be any entity that holds an account with a FI. Both the payer and payee are pre-registered with the CFMS 105 to use this method.

Throughout this document, the word “transaction” is not limited to actions that result in transfer of funds, such as payments. Transactions comprise multiple steps of communication between the different parties involved. In one example, the transaction encompasses all steps from sending a payment request to settling the payment.

Both customer 101 and merchant 103 may be individuals, such as natural persons, or non-individuals, such as a companies.

The computer systems of the customer FI 102 and the merchant FI 104 are connected to a central financial management system (CFMS) 105 via respective communication I/O ports using the internet or other wide area networks (WANs). The computer system of the merchant FI 104 are also connected to the merchant's computer system 103 that hosts the merchant's online shop via communication I/O ports using the internet or other WANs. As described further below, in this example messages sent to or from the I/O ports are comprised of data wrapped in Extended Marked-up Language (XML). Each message associated with the same online purchase transaction includes a unique transaction identifier allowing the different parties to associate subsequent messages received and sent relating to the particular online purchase transaction. For example, if the transaction is a payment, then a payment request and payment notification include the same transaction identifier.

The CFMS 105 also comprises one or more processors, that is a computer processing system such as a server 106 and a computer storage 107 such as non-volatile memory. The computer storage 107 stores for each customer or merchant, the following information as appropriate:

user data, that is a unique user identifier and FI associated with the user identifier,

display details, such as the name published with the user identifier, the user type (e.g. individual, business, government), official identification numbers (e.g. ABN, ACN),

allowable usage information (e.g. accept real time notifications? payment requests? online transactions?),

blocked list information, that is other user identifiers that are blocked from sending messages to this user identifier,

limit information, minimum and maximum values that can be received or sent by the user identifier,

transaction history, that is information of all transactions performed using the identifier stored by the CFMS as they occurred,

other information associated with the identifier, such as auto pay rules and scheduled payment information.

For each FI in their role as a merchant FI the following is also stored associated with the merchant's user identifier: standing instructions, that is whether they require the ability to veto (e.g. cancel) a payment request of payment notification message

The CFMS 105 also stores in the computer store 107 a payments file. This file includes information of payments that have been authorized according to this method but actual funds transfer (settlement) between the customer FI and the merchant FI has not yet occurred.

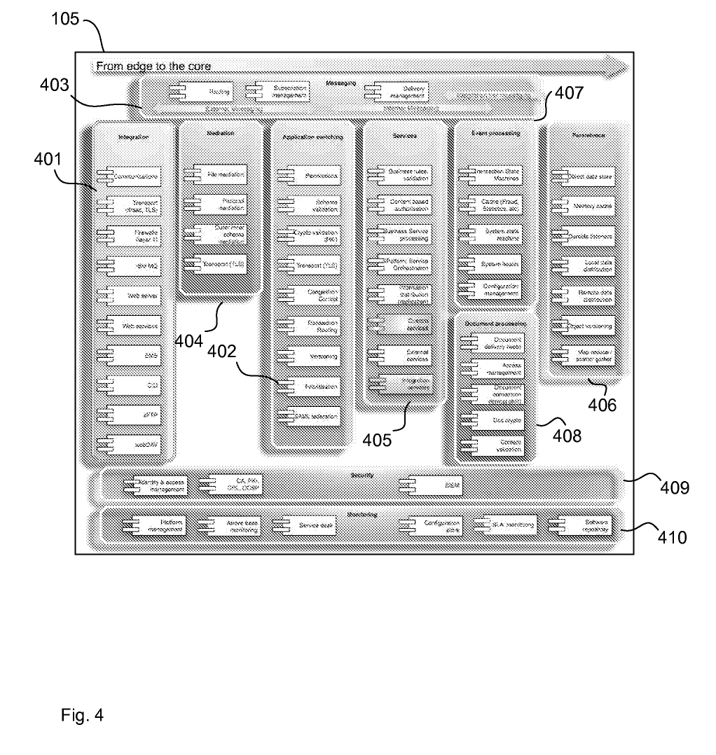

The CFMS 105 also has installed software that the server executes to perform the method described here, which includes querying and updating the computer storage 107 and generating and sending messages to the customer FI 102, merchant FI 104 and merchant 103 as appropriate. This is described in more detail further below in relation to FIG. 4.

The customer FI 102 also has computer storage (not shown) that stores for each customer identifier:
associated verification code
associated account information, such as account identification information and current balance
transaction information, including payments
allowable user information
any issued authorization codes
method for communication of authorization codes with the customer, such as SMS or email

The customer FI 102 also have installed software that a processor executes to perform the method described here.

The merchant FI 104 also has computer storage (not shown) that stores for each merchant identifier:
associated account information, such as account identification information and current balance
transaction information, including received payments

The merchant FI 104 also has installed software that a processor executes to perform the method as described here.

For simplicity only one customer 101, customer FI 102, merchant 103 and merchant FI 104 are shown in FIG. 1, however it should be understood that in practice multiples of each entity each using one or more computer systems participate in this system 100. Also, in some cases the customer FI 102 and the merchant FI 104 may be the same entity.

When in use, customer 101 purchases goods or services from the online store of the merchant 103. A person skilled in the art will readily appreciate the different ways the online store of the merchant 103 can be hosted and accessed by the customer 101 using a computer device, such as a personal computer or smart phone. Examples include through an internet browser, such as Microsoft Internet Explorer, Mozilla Firefox or Google Chrome, or a dedicated software application (software app) or smart phone application.

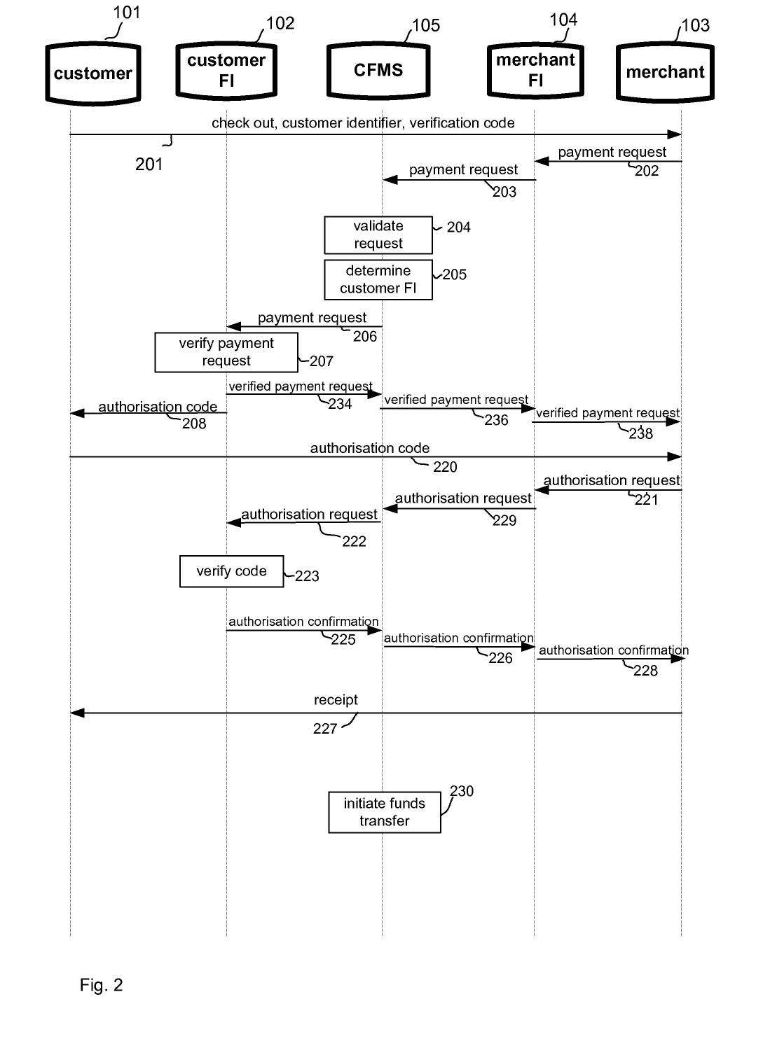

In this example, the payment between the customer FI 102 and the merchant FI 104 is facilitated by the CFMS 105 such that the merchant 103 receives a payment authorization confirmation after a short time, such as 5 seconds. That is the document transfer is performed in real-time. The method of this example will now be described with reference to FIG. 2.

The customer finalises a purchase from the online store of the merchant such as by clicking on a checkout button and then providing as input an indication of an intention to pay using the method described here. The merchant website then displays to the customer a form allowing the customer to provide 201 as input a customer identifier and a verification code, such as a password, to the merchant 103.

The merchant generates a message 202 that includes a payment request that has in this example:
unique transaction identifier,
a payment amount,
the customer identifier,
the customer verification code,
merchant identifier,
a description of the purchased items; and
time information.

The merchant sends 202 the payment request message to the merchant FI. The merchant FI verifies the payment request message such as checking that the merchant identifier is valid, the associated account is set up to receive payment in accordance with this method and the payment amount does not exceed the predetermined limit of this merchant or all merchants of the merchant FI. The merchant FI stores the payment request in the computer storage and then sends 203 a message including the payment request to the CFMS 105.

The CFMS receives the payment request message and stores in memory 107 a persistent object to represent this transaction. More details of the processing of messages received by the CFMS 105 is described in further detail below. The CFMS 105 validates 204 the payment request, for example checking that time and date is not in the future, that the payment amount does not exceed the limit predetermined for online payments using this method, and the allowable usage information of the merchant identifier is that receipt of payments using this method is allowed.

The CFMS then determines the customer FI from the customer identifier included in the payment request. That is, the CFMS identifies in the computer storage the customer FI currently associated with the customer identifier. Based on the merchant identifier included in the payment request the CFMS also determines the display details, such as the merchant's name, stored in the computer storage.

The CFMS sends 206 the payment request message to the determined customer FI that now includes the display name of the merchant. The customer FI receives the payment request message and verifies 207 the payment request message 203 by comparing the verification code with the verification code stored in the customer FI's computer storage associated with the received customer identifier. By verifying the verification code the system helps to prevent the customer from receiving unsolicited payment requests since the method of this example stops once any validation or verification step is unsuccessful, for example should a customer mistype their customer identifier that actually identifies a different customer or 5 consecutive unsuccessful attempts have been made. At the same time, should any unauthorized person gain access to the customer's verification code the only malicious use of the verification code is to cause unsolicited payment requests to be sent to the customer.

The customer FI also validates the message by checking whether sufficient funds are available in the account, the transaction limit is not exceeded, this transaction is in the allowable usage for the customer identifier and all other requirements are met.

If verifying 207 the payment request by the customer FI was successful, authorization of the payment is now performed to help provide that the payment process was in fact initiated by a purchase of the customer and not by a third party that gained access to the customer identifier and verification code. The customer FI sends 208 an authorization code message to the customer via an independent communication channel, such as SMS or email. The independent channel may be preselected by the customer and previously stored by the customer FI. The message 208 includes details of the purchase as extracted from the received payment request message 206, such as a list of purchased items, the name of the merchant, the payment amount and a single use authorization code. The authorization code is generated by the customer FI and is unique to the payment request (transaction). The customer FI associates the authorization code with the payment request and stores the payment request, the associated authorization code and the time that the authorization code was sent in the computer storage of the customer FI. In one example the authorization code is a six digit character string or use of a one-time token generator such as RSA SecurID.

The customer FI confirms to the CFMS 105 that verification of the payment request was successful by sending a verified payment request message 234 to the CFMS 105 that includes the transaction identifier and a status indication of successful verification. This confirmation of verification is in turn sent 236 to the merchant FI 104 and then to the merchant 238. This causes the merchant 103 to present via the website a new form to the customer 101 that allows the customer 101 to provide as input the received authorization code, such as a pop up box or updating the displayed interface to the online store.

The customer receives the authorization code 208 from the customer FI and enters the authorization code into the new form on the merchant's online store. The customer submits 220 the form so that the authorization code is sent 220 to the merchant. The merchant receives the authorization code request, validates the request, and generates an authorization request message that includes the transaction identifier and the received authorization code and sends 221 the authorization request message to the merchant FI. The merchant FI 104 then validates the authorization request message and then sends 229 the authorization request message to the CFMS 105.

The CFMS 105 also verifies the authorization request message, for example determining that the original payment request for the transaction has expired based on time information included in the payment request. The CFMS again determines the customer FI associated with the payment by reference to the transaction identifier which in turn identifies the customer identifier from which the associated customer FI can be identified. The customer FI updates the datastore to reflect that the status of the transaction is that an authorization request message has been received. The CFMS then sends 222 the authorization request message to the customer FI.

The customer FI again validates the payment request, for example to provide sufficient funds remain in the customer's account. The customer FI then verifies 223 the authorization code to check that the received authorization code matches the authorization code sent to the customer for this transaction request. The customer FI updates its datastore by updating the records for the customer's account to include payments together with details of the purchase as contained in the original payment request message.

The customer FI 102 also deducts the payment amount from the available funds to make sure that subsequent payments are checked against the reduced available funds even though the actual funds transfer happens at a later time, such as over night or on the next banking day.

The customer FI 102 then sends 225 an authorization confirmation to the CFMS 105. The CFMS 105 again updates the datastore to record the status of the transaction authorization received and sends 226 the authorization confirmation to the merchant FI. The merchant FI again performs validation checks. The merchant FI then updates the records of the merchant's account to reflect this payment receipt. For example, add the payment amount to the available funds and stores the payment receipt information for access by the merchant.

The CFMS 105 stores the transaction data, that is the data related to the payment, in the data store such that a history of all transactions including registration of documents is available. The customer FI 102 can download the transaction history from the CFMS 105 and make the history available to the customer 101 without generating additional traffic for the CFMS 105.

The CFMS then initiates 230 the funds transfer for the payment by committing the transaction, that is by storing the payment details in the payments file that will be settled across all the FIs at the close of business that same day and therefore the provision of the purchased goods or services to the customer.

In one example, the messages received by the CFMS 105 include the customer FI or merchant FI or both. Therefore, the CFMS 105 can determine the FI that is the recipient of the next message simply from the data in the messages. In a different example, all messages include only the user identifier of the customer and the merchant. In that case the CFMS 105 queries the database to determine the FI after receiving message. Although in this example there is another database lookup required, the process is more robust against inconsistencies due to changing FIs. Alternatively, the customer FI and merchant FI may be associated with a record of the transaction in storage and determining involves querying the storage.

If the payment request remains unnoticed by the customer 101 for an extended period of time, the merchant 103 may change financial institutions during that time. When the merchant 103 changes FIs, the database in the CFMS 105 is updated but it is complicated and error prone to update the data in all pending payment requests. Therefore, it is advantageous to query the database of the CFMS to determine the payee FI since the payment notification can then be sent to the changed payee FI. The same applies for all other messages between the customer FI 102, the merchant FI 104 and the CFMS 105.

It is noted that the step 230 of initiating the transfer of funds is performed after step 226 of sending the authorization confirmation to the merchant FI. In fact, the transfer of funds may be initiated at a later stage, such as over night, without delaying the confirmation to the merchant.

Alternatively, immediate settlement may be an option and indicated as such in the original payment request message for the transaction.

Once settlement occurs the status of the transaction as recorded by the CFMS is updated accordingly.

Once the merchant receives the payment confirmation, the merchant confirms to the customer payment has been accepted and confirms successful payment such as a display message by providing 227 a payment receipt. This payment receipt may be displayed on the website of the online store or sent to the customer via email. Even further, the receipt may be provided as a document.

Since the payment request is sent to the customer FI, the customer FI stores the details of the payment request. The customer FI can provide a list of recent payments to the customer that includes more details than currently are provided by online banking websites including a link to the receipt as stored by the CFMS and merchant or customer FI. The customer FI can distinguish itself from competitors by the way the customer FI conveniently presents the information to the customer. The customer FI may also further process the information from various authorized payment requests to provide the customer with an aggregated view, such as a total sum of payments to one particular merchant over the last financial year.

In the same way the payment request and authorization confirmation message received by the merchant FI allows the merchant FI to associate more information with a received payment in the merchant's account as cleared funds.

It should be understood that the content of messages received by the CFMS 105 and then sent forward may change in content, both with content removed and content added. In the example above content was added by adding the merchant display name. In other examples a merchant FI identifier can be included in the payment request 203 or 202 but is removed before sending 206 to the customer FI 206.

Verification by the CFMS

In an alternative the verification code is stored by the CFMS in addition or instead of the customer FI. In this way the CFMS can perform the verification step 207 and change the status of the transaction as recorded to verify and pass this information with the payment request 206 to the customer FI.

No Verification Code

A trusted relationship may exist between the merchant and customer. Alternatively, the transaction may be of a type where verification is not required, for example purchases of a very small amount. In this case the verification of the verification code 207 can be omitted from the method, in which case the verification code is not included as part of the payment request 203.

No Authorization Code

A form simply related to the present disclosure is where a trusted relationship may exist between the merchant and customer. Alternatively, the transaction may be of a type where authorization code is not required, for example purchases of a very small amount. In this case the authorization workflow will be omitted and the transaction completes in a single iteration when message 238 is sent to the merchant.

Merchant Payment Gateway

The merchant may communicate with the CFMS or the merchant FI as appropriate via a payment gateway (not shown). In FIG. 1 and FIG. 2 it is assumed that the merchant 103 and payment gateway are one in the same. Alternatively, a person skilled in the art would readily appreciate that the merchant and the payment gateway may be separate computer systems. In this case all messages sent to or from the merchant 103 are sent by the payment gateway, with the result of the transaction being successful or unsuccessful is sent to the merchant by the payment gateway.

Less Communication with the Merchant FI

In one alternative the merchant (typically via their gateway) may communicate directly with the CFMS 105 and vice versa rather than through the merchant FI. In this alternative the merchant FI has no involvement with the authorization of the payment request other than to receive a payment authorization confirmation message from the CFMS or the customer FI.

For this alternative the entry of new payment gateways is facilitated since the payment gateway only needs to certify one (the CFMS') messaging interface to support all the participating FIs rather than a different build and certification process for each FI.

Less Communication with the Merchant FI but Merchant FI with Right of Veto

In this alternative, the communication with the merchant FI is reduced as described directly above but the merchant FI has the right of veto—that is the merchant FI may wish to validate the payment request before it is processed further by the CFMS.

In this alternative the CFMS determines whether the merchant FI has requested a right of veto when the CFMS receives the payment request message 202 directly from the merchant.

If the merchant FI has requested a right of veto then the CFMS sends the required message to the merchant FI who then performs validation checks, such as fraud checks, and then sends a message back to the CFMS. In this case the CFMS does not perform any further steps unless the reply message indicates the validation by the merchant FI was successful.

If the merchant FI has not requested a right of veto a notification message is simply sent to the merchant FI.

Payment Receipt Number

The merchant may include on the payment request 202 a field called end-to-end transaction identifier. This is included in all subsequent messages sent for a transaction and accordingly stored by CFMS, merchant FI, the customer FI and where appropriate the merchant for future reference. This is in addition to the standard transaction identifier discussed above. This end-to-end transaction identifier can then be in both the relevant transaction records of the customer and merchant. For example, the end-to-end transaction identifier can be provided to the customer by the customer FI with the transaction in the customer's banking records for the relevant account.

Failure

As described above the merchant FI, CFMS and customer FI all perform validation and authentication checks. If any of these checks fail that entity can cause the method described above to stop and the appropriate failure messages to be sent.

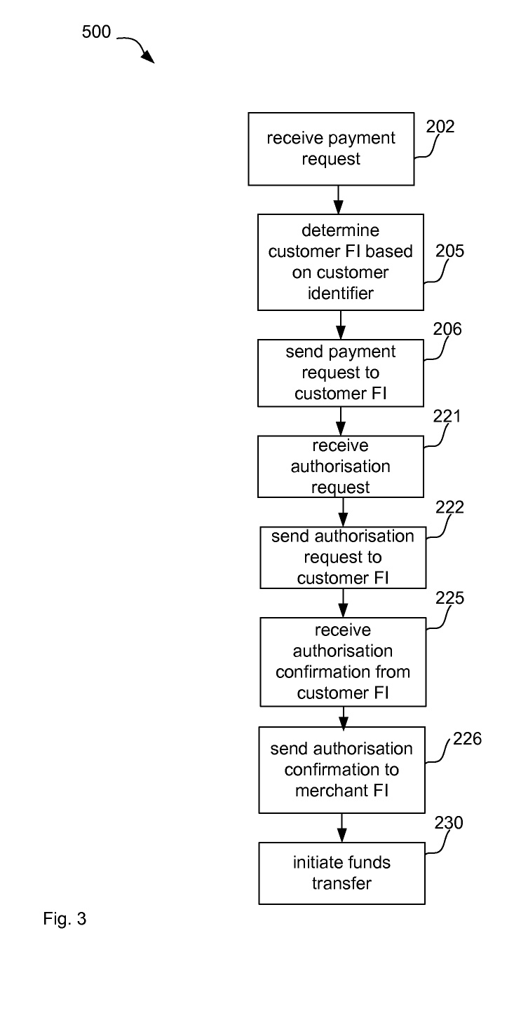

FIG. 3 illustrates as a flow diagram the steps performed by the CFMS in authorizing a payment as described above in relation to FIG. 2.

FIG. 4 illustrates the CFMS 105 in more detail in form of an application layer decomposition by functionality. One of the layers comprised by the CFMS 105 is an integration layer 401. This layer is the application gateway into the CFMS 105. In the OSI stack this translates into all communication from layers 4 to 7. This includes name services (DNS), including proximity and topology based DNS resolution of system resources for the clients. This is achieved by the global traffic manager (GTM) functionality of the F5 Big-IP platform. Resource based load balancing is implemented within the CFMS 105, where incoming connection requests are directed to the application host. This redirection can be based on application specific service matrix, including, sticky, round-robin or least count etc.

This layer allows to better manage the resources as well as, in event of an application node failure, it also allows to seamlessly re-direct the request to surviving application nodes. The integration layer 401 also comprises IBM MQ Services, including Queue management, routing, recovery, redundancy of traffic using IBM MQ application.

The CFMS hosts its own queue manager framework. The queue manager provides the low level technical ack, nack and time-outs functionality. Web services, for synchronous communication are also integrated into the integration layer 401. Web services are screened for security issues using the Application Security Manager (ASM) from the F5 Big-IP product modules. The integration layer 401 further comprises web servers for all web requests for document retrieval as well as file upload, download for bulk file integration using Web-based Distributed Authoring and Versioning (WebDAV) method. Connect:Direct and Secure Shell File Transfer Protocol (sFTP) is used for the file transfers. All file transfers are managed from network file shares. The file mediation services in the mediation layer make use of the file system events to initiate the file processing. This is more efficient then polling a file system.

CFMS further comprises an application switching layer 402 performing the functionalities of content based routing, message validation services and Security Assertion Markup Language (SAML) federation.

The application switching layer routes messages based on “affinity” where functions are stateful, such as complex event processing functions. For example, a transaction involving two other parties should be processed at a single service tier. However, messages from participants may be delivered to via any data centres of the CFMS or components within the data centres.

In the distributed CFMS a message related to a transaction may be received by a location or stack not processing the specific transaction. The application switching layer 402 will identify the correct processing stack and route the message over. The routes of the messages are based on version of the schema used.

The application switching layer 402 prioritises messages based on importance of a message at a business layer, such as a block address request as part of fraud management.

The application switching layer 402 provides message validation services for confidentiality and assurance (decryption, encryption, signing, signature validation), access control (permissions and roles), technical validations (e.g., XML wellformedness) and business validations (higher level validations, if any) and SAML federation. This is used for processing document retrieval requests received by the CFMS 105. It involves validation of the assertion, invoking request to the back-end services and coordination of the response including additional SAML assertions to the caller.

CFMS 105 also comprises a messaging layer 403. The messaging layer 403 is a distributed high speed messaging tier that allows for very low latency and asynchronous message exchange in a reliable fashion. In line with the N+1 design principles, the messaging grid will autonomously recover from component failures. Each messaging server has a warm standby which allows for near instantaneous and stateful recovery with zero data loss. The messaging functionality includes queue, topics and subject based communication as well as integration with presence—for example based on Extensible Messaging and Presence Protocol (XMPP) or Remote Authentication Dial In User Service (RADIUS) events for end-point detection for transmission. The messaging functionality also includes message routing within and across the stacks and message level priority management and congestion control.

Three distinct messaging layers operate across the CFMS 105: external messaging, internal messaging and integration messaging. These layers are based on three distinct security zones. There is an additional messaging service used by the monitoring services.

Each messaging layer is to support the application services hosted at that tier and typically align with the security zones. There is no message routing crossing the security zone. All messages crossing the security zones will always go through a mediation layer 404.

Mediation layer 404 comprises message transformation services to transform messages from external to internal or vice-versa or from external to external.

The mediation layer 404 also comprises orchestration functionality for integration with the core of the CFMS 105, detection of duplicates, stripping of documents and integration of document processing, bulk file iteration and response collator integration.

An internal facing mediation tier provides integration with settlement engine, which includes real time messaging integration for continuous streaming of information as the transactions take place and once a day files processing such as updates to Biller Master File (BMF). The internal facing mediation tier also provides integration with an Ops Portal that also includes file transport functionality where members can submit instructions by Bulk file and collect responses to the bulk files submitted by them. The internal facing mediation tier further provides billing and business intelligence.

CFMS further comprises a service layer 405. This layer is where bulk of service functions are orchestrated based on the needs of various patterns. The services also include functionality for error correction, capturing errors and compensating actions. Some of the service functions will be bespoke to meet specific requirements. These include creation of the user identifier, transaction reference, universally unique identifier (UUID) generation with site affinities, etc. The services are hosted within the enterprise service bus (ESB) and communicate using messaging layer. The service layer is stateless while orchestrations are stateful. Complex event processing systems are used to manage and maintain the states as well as the state transformation machines.

One of the key functions hosted out of the services layer is integration with a persistence layer 406. The persistence 406 is provided by a Data Grid. The data access is abstracted at the service bus. The data access functions facilitate replication of data across all data grids where replication is addressed as part of the business transaction. This allows provisioning of additional system capacity in a near linear scalable fashion. Additional capacity can also be provisioned on demand. This design approach also allows for quick re-purposing of capacity for other functions. For example, the document rendering/processing capacity could be increased during end of the financial year period for capacity and service level management.

The CFMS 105 will have several service buses to meet requirements in different security zones:

a) External Demilitarized Zone (DMZ), to allow for functions such as duplicate transaction detection, enforcement of allowable usage types, and address allocation maps.

b) Document processing, to allow for all orchestration to process, store and retrieve documents. There are a few integrations with bespoke code, and appliances.

c) Internal, will include all other technical services. The internal services includes where orchestrations span stacks and/or sites. Orchestration across stacks, sites may be used where replication is part of business transaction.

Another layer within the CFMS 105 is an events processing layer 407 which is the control tier of the CFMS applications. One of the core functions that this application layer provides is managing and maintaining transaction states. This is achieved by state-transition-machines. State machines are defined for each transaction flows. It is the state machine that orchestrates the transactions provides event correlation with the other components of the CFMS 105 such as document processing provides the time-based event processing for TTRs.

The state machines are typically initialised by the first message/event in a transaction or instruction received by the CFMS 105—in this case a payment request. In that case, a transaction identifier is created and the state machine is associated with the transaction identifier. Subsequent processing and functions performed on the transaction result in events being generated. These events are relayed back to the state machine and based on the event it undergoes state changes. Once a transaction is complete and committed—in this case the payment is written to the payments file, the state machine is destroyed.

The event processing engine is also used for real-time collection of intelligence, such as fraud and statistical data generation for the user identifier. These statistics are kept hot and up to date as transactions are processed.

As mentioned above, the persistence is achieved by a data grid which is coordinated by a persistence layer 406. Geographic reach of the data grid together with a data grid provide internal replication in real-time to both the intra and inter grid members. The data grid will be built to provide a deterministic N+1 or better redundancy. This will allow the data grid to autonomously recover from component failures, sacrificing neither the data quality nor the data reliability. Persistence applies to entities that need to be persisted and entities that need to be accessible for all of above to work.

The CFMS applies a shared nothing architecture. In order to achieve higher resilience and availability, non-blocking and near linear performance scalability, the data grid nodes will make use of direct attached storage. This also removes any single points of contention and single points of failure from the persistence tiers. This also reduces complexity in design by removing the need for Storage Area Network (SAN).

The data within the CFMS 105 needs to be consistent across all data centres. This requires data to be distributed as the data changes as part of various transaction flows. Within a transaction flows there are pre-defined commit points where recoverability and consistency needs to be provided. For example, at some key points the system needs to provide that data is also at the other data centre. These two points need to be synchronous. However, all other replication and data distribution within this transaction flow can be asynchronous.

The CFMS 105 further comprises a document processing layer 408. The CFMS 105 will be processing documents included as attachments, including non value instructions. This is for use where a document or uniform resource locator (URL) or uniform resource identifier (URI) is attached to the message.

The CFMS further comprises a security layer 409. The security layer 409 performs identity and access management employing a multi-factor authentication subsystem, a Certification Authority (CA) component and a role based access control subsystem. The multi-factor authentication subsystem provides strong authentication and integration with the federation components for admin and operator authentication and access control. The CA component provides X.509 certificate provisioning and management facility. The CA also provides a Certificate Revocation List (CRL) and Online Certificate Status Protocol (OCSP) services to ascertain validity/currency of X.509 certificates as part of the mutual authentication flow. The role based access control sub system will link identity to entity and their roles and access rights.

The security layer 409 also performs Security Incident and Events Management (SIEM), exception handling and management. To perform these tasks the security layer 409 employs logging components and correlation engines. The logging components provide a centralised facility to log all the messages and events, including network devices, security devices and services. This information can be used to debug and trace events and correlations between various events. The correlation engines are used to identify related events, patterns for security and other compliance escalations.

The security layer 409 also performs operational monitoring and maintenance, such as vulnerability assessment including intrusion detection and internal and external vulnerability scanning.

Further, the CFMS 105 comprises a monitoring layer 410. As part of the handover to Technology Operations and production readiness five scenarios will be tested to meet the integrity and recoverability targets:

deep polling and synthetic transactions;

split-brain;

recovery;

cold boot; and

application maintenance and upgrades.

Split-brain can happen if one data centre hosting the CFMS 105 loses visibility to the other data centre and as a result islands itself. This may force each data centre to autonomously infer that it is the last surviving node and the other node is down. Automatic detection of split-brain using third party quorum, majority detection which would result in one of the two data centres to be taken down as active to pending consistency status.

The layering of applications within the CFMS 105 in this form allows for seamless horizontal and vertical scalability by bolstering components at each layer as required. This specific design also assists in managing performance and service levels and helps in limiting the impact of changes which will be required during the lifecycle of the CFMS 105. As a result, the overall maintainability, scalability and in turn availability of the CFMS 105 is improved. For example, introduction of messaging based on the Advanced Message Queuing Protocol (AMQP) will only require additions to the integration layer 401 and mediation layer 404.

An example of using the application layers of the CFMS 105 will now be described, The method of this example is described above as “less communication with the merchant FI but merchant FI with right of veto”, the payment request 202 in FIG. 2, arrives at the CFMS 105 as an encrypted Extensible Markup Language (XML) message. The message is received by a web service of the integration layer 401. In other examples the message is received via an encrypted channel, such as IPsec, between the merchant 103 and the CFMS 105. The integration layer 401 sends a transport level acknowledgment to the merchant 103.

The message is handed over to the mediation layer 404, which converts the message from the outside schema to an inner schema. The mediation layer 404 converts messages from various different protocols into the same inner schema. Now that the message is in a suitable format for internal layers, it is forwarded to the application switching layer 402. The application switching layer 402 validates the encryption of the message including the validity of the key and routes the message to the appropriate module of the services layer 405.

In a different example, the integration layer, mediation layer and application switching layer are combined into a communication and mediation layer. This communication and mediation layer may act as in input and then receives an input message from an external sender, validates the input message and sends the input message to the internal service layer 405. This communication and mediation layer may also act as an output and receive an output message from the internal service layer 405 and send the output message to an external receiver.

The services layer 405 orchestrates the communication pattern that is necessary for completing the online payment process. As mentioned above, the service layer 405 is stateless and therefore, the services layer 405 instructs the events processing layer 407 to initialise a state machine according to a predefined communication pattern. This state machine information needs to be persistently stored in the persistence layer 406 even in the event of a failure of an entire data centre, such as in case of a natural disaster. Therefore, at this stage, the state machine information is duplicated to a second data centre in sufficient geographical distance from the first data centre. The further processing of the request needs to wait for the completion of the storing at the second data centre.

When a payment request is first received 202 by the CFMS 105 the state machine is initialised and made durable in the persistence layer 406 and the services layer 405 can query the state machine for the next step. In this case, the next step is to send a copy of the payment request to the merchant FI 104. The payment request passes the application switching layer 402, the mediation layer 404 and the integration layer 401 and is sent to the merchant FI 104 for the right of veto. This starts a timer to detect a time out of the response of the merchant FI 104. After technical validation by the merchant FI 104, the integration layer 401 receives a response message acknowledging the correct transmittal of the payment request. This acknowledgement is passed to the mediation layer 404 to further monitor the responsiveness of the merchant FI 104.

Once the merchant FI 104 generates a confirmation and sends it to the CFMS 105, the confirmation is received by the integration layer 401 and passes through the mediation layer 404 and the application switching layer 402 to the services layer 405. Receiving the confirmation prompts the services layer 405 to advance the state of the state machine stored in the persistence layer 406 to the next state. As mentioned previously, the state of the state machine needs to be persistent and therefore, the duplication of the state change to a second data centre is again necessary.

After this step of advancing the state machine, the services layer 405 interacts with the persistence layer 406 to validate 204 the payment request and determine 205 the customer FI. Then, the service layer 405 generates a message including the payment request for the customer FI 102. This message passes through the application switching layer 402, the mediation layer 404 and the integration layer 401. The messages is then sent to the customer FI 102.

If the customer FI 102 in order to create the authorization, sends an authorization code to the customer 101, then the receiving 229 and sending 222 of the authorization code by the CFMS 105 follows similar scheme as the three party scheme described above.

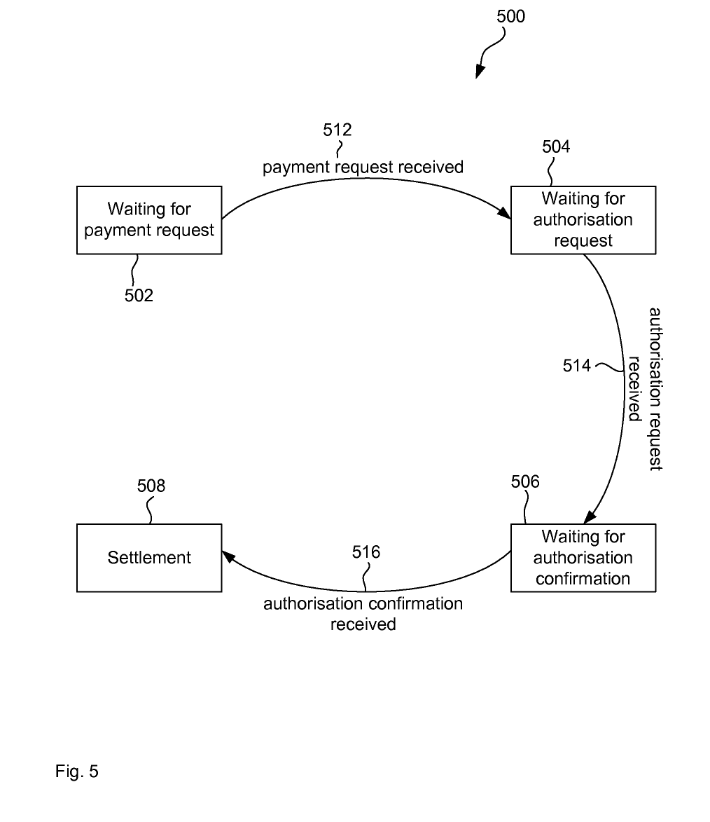

FIG. 5 illustrates a state transition diagram 500 for the state machine stored in the persistence layer. Payment requests, authorization requests and authorization confirmations are associated with a specific payment transaction via the transaction identifier as described above. In turn, each payment transaction is associated with one state machine. As a result, when receiving a message related to a specific transaction the service layer can access the state machine and the current state stored in the persistence layer 406 for that transaction.

The state transition diagram 500 comprises four states, waiting for payment request 502, waiting for authorization request 504, waiting for authorization confirmation 506 and settlement 508.

After initialisation the current state of the state machine is wait for payment request 502. In a different example, the state machine is not initialised before a payment request is received. As a result, the state of wait for payment request is not required in that example.

The communication and mediation layer as described above receives an input message from a sender, validates the input message and sends the input message to the service layer 405. Examples of validation are described above.

In a first case the input message is a payment request. In this case the service layer 405 determines a customer identifier, a merchant identifier and purchaser information based on the input message. With this information the service layer looks up the customer FI in the persistence layer 406 in FIG. 4. The service layer 405 also creates an output message that includes the payment request and sets as the recipient the customer FI. This output message including the payment request causes the customer FI to send to the customer an authorization code that is associated with the payment. The service layer 406 sends the output message to the communication and mediation layer and creates a state machine associated with the transaction identifier from the message. The predetermined state transition logic present in the state machine causes the current state stored in the persistence layer 406 to be advanced 512 to waiting for authorization request 504.

In a second case the input message is a payment authorization request and includes the authorization code as provided by the customer to the merchant and the current state of the state machine associated with the transaction identifier from the message is waiting for authorization request 504. In this case the service layer 405 determines the customer FI and creates an output message having the customer FI as recipient. This output message including the authorization request causes the customer FI to verify the authorization code. The service layer 405 then sends the output message to the communication and mediation layer. The predetermined state transition logic present in the state machine causes the current state stored in the persistence layer 406 to be advanced 514 to waiting for authorization confirmation 506.

In a third case the input message is an authorization confirmation and the current state of the state machine associated with the transaction identifier from the message is waiting for authorization confirmation 506. In this case the service layer 405 determines the merchant FI and creates an output message having the merchant FI as recipient. This output message includes the authorization confirmation and provides confirmation to the merchant FI that the payment has been authorized. The service layer 405 then sends the output message to the communication and mediation layer. The predetermined state transition logic present in the state machine causes the current state stored in the persistence layer 406 to be advanced 516 to settlement 508.

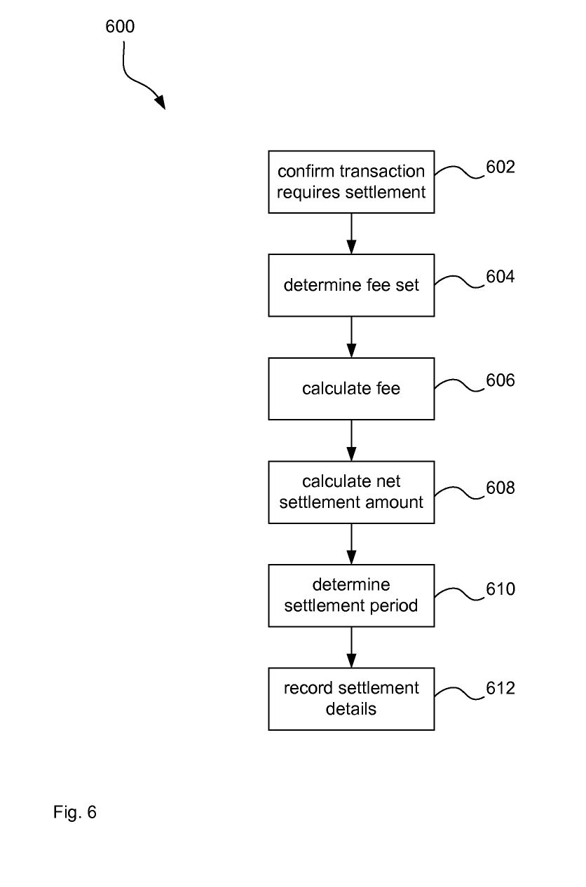

FIG. 6 illustrates a method 600 for creating settlement details. The method 600 commences by confirming 602 that the transaction requires settlement. The confirmation 602 comprises determining a transaction type, a transaction pattern and the number of parties involved in the transaction pattern. If the number of parties involved is 3 or 4 the method continues with the next step, otherwise settlement is not required and method 600 terminates.

The next step of method 600 is to determine 604 an appropriate interbank fee set. This step comprises determining the merchant FI and the customer FI, determining whether there is a set of interbank fees for this pair of FIs and if yes using the specific set of interbank fees. If no set of interbank fees can be found for this pair of FIs, a predetermined default set of interbank fees is used.

After determining the set of interbank fees the method then calculates 606 the interbank fee and fee direction. For that, the method determines the characteristics of the transaction relevant to settlement, that is transaction type, fee basis for each user identifier, transaction attachments, and payment amount. From the appropriate set of interbank fees the method also matches the transaction characteristics with the interbank fee characteristic. If a match is found, the transaction interbank fee is calculated as:

a flat fee(if stated)+the fee rate in percent*payment amount.

The calculated fee may then be corrected by applying a minimum and maximum interbank fee. Finally, the fee direction as read from the set of interbank fees.

With the calculated fee the net settlement amount is then calculated 608. This is achieved by either adding to or subtracting from the payment amount the calculated fee depending on the fee direction.

The method then determines 610 the settlement period details. This step comprises based on a timestamp of the committed transaction determining the next closing date and time for settlement and identifying an associated settlement period ID and banking business day.

The last step of method 600 is to record 612 the settlement details. The recorded data comprises in this example:
transaction amount;
interbank fee amount and non-GST settlement amount determined in step 606;
the user identifier of the customer;
the user identifier of the merchant;
settlement period details determined in step 610;
transaction type;
fee basis and version number of the customer user identifier; and
fee basis and version number of the merchant user identifier.

Before the transaction details are recorded in a settlement record table, this table is updated. Then it is determined whether there is an entry in the table that matches the settlement period ID, closing date and time of the settlement period, banking business day, customer user identifier, merchant user identifier, source account type, transaction type, attachment indicator, fee basis of the customer user identifier and fee basis of the merchant user identifier. If no match is found, a new record is written to the settlement record table and a transaction count is incremented by 1.

After that the transfer amount, the interbank fee amount and the settlement amount are added to the respective base amounts. Then, a record is added to the settlement details table.

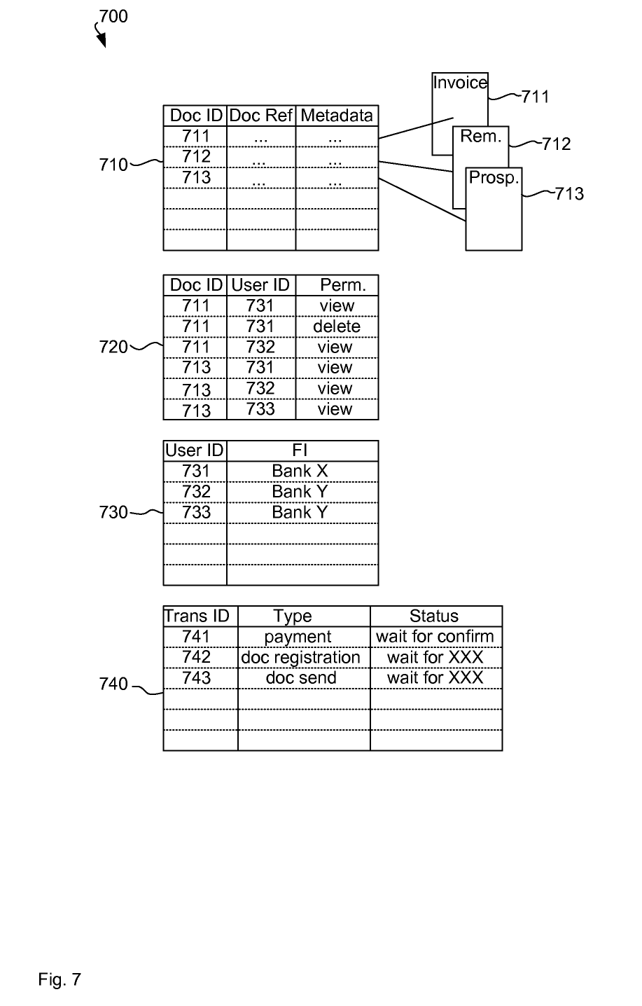

FIG. 7 illustrates data 700 on a data store comprising a document table 710, an access control table 720, a user data table 730 and a transaction data table 740. The tables are accessed by different layer from FIG. 4. For example, the document table 710 and access control table 720 are accessed by the document processing layer 408 while the transaction data table 740 is accessed by the event processing layer 407.

The document table 710 stores data related to documents registered with the CFMS 105. Each entry in the document table 710 stores the association between the document identifier, the document reference and the document metadata. When in use, the CFMS 105 accesses the document table 710 to store a new entry when a new document is registered. The CFMS 105 retrieves the document data and in particular the document reference when the document is requested. In this example, three document are registered, that is an invoice 711, a remittance advice 712 and a prospectus 713.

The access control table 720 stores information about which user has certain rights to certain documents. It is noted that one document identifier can have multiple entries in the access control table 720. In this example, a first user 731 has permission to view and delete document 711 while a second user 732 has permission to only view document 711. Typically, if document 711 is an invoice user 731 is the payee who has sent the invoice to user 732 who is the payer. The payee 731 can view and delete the invoice while the payer 732 can only view the invoice. Similarly, if the document 712 is a remittance advice, a payer can view and delete the remittance advice while the payee can only view the remittance advice. In contrast, the prospectus 713 may be sent to many different users and therefore the access control table stores many entries to grant permission to view the prospectus to many users.

Every time a document is attached to a transaction from a sender to a receiver, the CFMS 105 checks whether an entry already exists in the access control table and if not creates a new entry allowing the sender to view and delete the document and the receiver to view the document.

The user data table 730 stores an association of the user identifier with an FI. In this example, user 731 has an account with bank X while users 732 and 733 have their accounts with bank Y. When a new user registers with the CFMS 105, the CFMS 105 creates a new entry in the user data table. When a sender sends any transaction to that user identifier as receiver, the CFMS 105 queries the user data table 730 to determine the FI of the receiver and sends the transaction to the receiver's FI.

The transaction data table 740 stores data related to transactions which are currently pending. In this example, transaction 741 is a payment request and the CFMS 105 is waiting for a authorization request from the merchant FI. The CFMS 105 creates a new entry when the state machine is created. When the transaction is finished, such as by settling the payment, the entry in the transaction table 740 is deleted.

It will be appreciated by persons skilled in the art that numerous variations and/or modifications may be made to the present disclosure as shown in the specific forms without departing from the scope of the present disclosure as broadly described.

It should be understood that the techniques of the present disclosure might be implemented using a variety of technologies. For example, the methods described herein may be implemented by a series of computer executable instructions residing on a suitable computer readable medium. Suitable computer storage is readable media may include volatile (e.g. RAM) and/or non-volatile (e.g. ROM, disk) memory, carrier waves and transmission media. Exemplary carrier waves may take the form of electrical, electromagnetic or optical signals conveying digital data streams along a local or wide area network or a publicly accessible network such as the internet.

It should also be understood that, unless specifically stated otherwise as apparent from the following discussion, it is appreciated that throughout the description, discussions utilizing terms such as “receiving”, “sending”, “processing” or “computing” or “calculating”, “optimizing” or “estimating” or “determining” or “displaying” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

It will be appreciated by persons skilled in the art that numerous variations and/or modifications may be made to the present disclosure as shown in the specific forms without departing from the scope of the present disclosure as broadly described. The present forms are, therefore, to be considered in all respects as illustrative and not restrictive.

What is claimed is:

1. A computer implemented method performed by a central financial management system for authorizing a payment for a purchase by a customer from a merchant, the method comprising:
(a) receiving from the merchant or a financial institution of the merchant (merchant FI) an input message including a payment request having:
a customer identifier, and
purchase information;
(b) based on the customer identifier, determining a financial institution of the customer (customer FI) and sending an output message including the payment request to the customer FI to cause the customer FI to send to the customer an authorization code that is associated with the payment;
(c) receiving from the merchant or the merchant FI an input message including an authorization request associated with the payment having the authorization code as provided by the customer to the merchant;
(d) determining the customer FI associated with the authorization request and sending an output message including the authorization request to the customer FI to cause the customer FI to verify the authorization code;
(e) receiving from the customer FI an input message including an authorization confirmation for the payment; and
(f) determining the merchant FI associated with the authorization confirmation and sending an output message including the authorization confirmation to the merchant FI.

2. The computer implemented method according to claim 1, wherein the input message includes a merchant identifier and the method further comprises determining from the merchant identifier the merchant FI.

3. The computer implemented method according to claim 1, wherein the payment request further includes a customer verification code associated with the customer identifier, and step (b) further comprises verifying the verification code by comparing the verification with the pre-stored verification code associated with the customer identifier.

4. The computer implemented method according to claim 1, wherein the step (a) further comprises storing in computer storage a persistent object to represent the payment transaction having an associated status and storing an indication that the status is pending, and step (e) further comprises updating the status by storing an indication that the status is authorized.

5. The computer implemented method according to claim 1, wherein step (e) further comprises storing in computer storage an indication that the payment can be settled and
(f) determining whether an indication is stored that the payment can be settled and if so initiating the settlement between the customer FI and the merchant FI of the payment.

6. The computer implemented method according to claim 5, wherein step (f) further comprises initiating settlement of the multiple payments having an indication stored that the payment can be settled.

7. The computer implemented method according to claim 1, wherein the method further comprises based on the merchant identifier determining the merchant FI and sending the payment request to the merchant FI.

8. The computer implemented method according to claim 1, wherein the purchase information includes information of the goods or services to be purchased.

9. The computer implemented method according to claim 1, wherein determining the customer FI comprises using the customer identifier as a look up key in a computer storage that stores the customer FI associated with each of a plurality of customer identifiers.

10. The computer implemented method according to claim 1, wherein the method further comprises storing in computer storage associated with the payment request the determined customer FI and/or the merchant FI.

11. A non-transitory computer readable medium with an executable program stored thereon that when executed causes a computer to perform the computer implemented method according to claim 1.

12. A computer system of a central financial management service provider for authorizing a payment for a purchase by a customer from a merchant, the system comprising:
computer storage to store user data including a user identifier and associated customer financial institution (customer FI);
one or more communications ports to send and receive messages; and
one or more processors to operate the communications port to
(a) receive from the merchant or a financial institution of the merchant (merchant FI) an input message including a payment request having:
a customer identifier, and
purchase information;
(b) based on the customer identifier and stored user data, determine a customer FI and send an output message including the payment request to the customer FI to cause the customer FI to send to the customer an authorization code that is associated with the payment;
(c) receive from the merchant or the merchant FI an input message including an authorization request associated with the payment having the authorization code as provided by the customer to the merchant;
(d) determine the customer FI associated with the authorization request and send an output message including the authorization request to the customer FI to cause the customer FI to verify the authorization code;
(e) receive from the customer FI an input message including an authorization confirmation for the payment; and
(f) determine the merchant FI associated with the authorization confirmation and send an output message including the authorization confirmation to the merchant FI.

13. A computer system for controlling the authorization of a payment for a purchase by a customer from a merchant, the computer system comprising:
a persistence layer to store a status for the payment and user data including a user identifier and associated customer financial institution (FI);
a communication and mediation layer to receive an output message from a service layer, to send the output message to a recipient, to receive an input message from a sender, to validate the input message and to send the input message to the service layer; and
the service layer
to receive the input message from the communication and mediation layer,
where the input message includes a payment request, to determine a customer identifier, a merchant identifier and purchase information based on the payment request, to determine a customer FI based on the customer identifier and the user data in the persistence layer, to create the output message having the customer FI as recipient and including the payment request, that causes the customer FI to send to the customer an authorization code that is associated with the payment, to send the output message to the communication and mediation layer and to set the status in the persistence layer to waiting for authorization request,
where the status is waiting for authorization request and the input message includes a payment authorization request associated with the payment and having the authorization code as provided by the customer to the merchant, to determine the customer FI associated with the payment authorization request, to create the output message having the customer FI as recipient and including the authorization request, that causes the customer FI to verify the authorization code, to send the output message to the communication and mediation layer and to set the status in the persistence layer to waiting for authorization confirmation, and
where the status is waiting for authorization confirmation and the input message includes an authorization confirmation, to determine the merchant FI associated with the authorization confirmation, to create the output message having the merchant FI as recipient and including the authorization confirmation, and to send the output message to the communication and mediation layer.

14. A computer implemented method performed by a merchant or a financial institution of the merchant (merchant FI) for authorizing a payment for a purchase by a customer from the merchant, the method comprising:
(a) generating a payment request message having:
a customer identifier, and
purchase information;
(b) sending a message including the payment request to a central financial management system (CFMS) to cause the CFMS to send to a financial institution of the customer (customer FI) a message including the payment request;
(c) receiving from a customer an authorization code;
(d) generating an authorization request having the authorization code;
(e) sending a message including the authorization request to the CFMS to cause the CFMS to send to the customer FI a message including the authorization request;
(f) receiving from the CFMS a message including an authorization confirmation; and
(g) generating and sending to the customer a confirmation of successful payment.

15. A computer system of a merchant or a financial institution of the merchant (merchant FI) for authorizing a payment for a purchase by a customer from the merchant, the system comprising:
one or more communications ports to send and receive messages; and
one or more processors to operate the communications port to:
(a) generate a payment request message having:
a customer identifier, and
purchase information;
(b) send a message including the payment request to a central financial management system (CFMS) to cause the CFMS to send to a financial institution of the customer (customer FI) a message including the payment request;
(c) receive from a customer an authorization code,
(d) generate an authorization request having the authorization code;
(e) send a message including the authorization request to the CFMS to cause the CFMS to send to the customer FI a message including the authorization request;
(f) in reply, receive from the CFMS a message including an authorization confirmation; and
(g) generate and send to the customer a confirmation of successful payment.

16. A non-transitory computer readable medium with an executable program stored thereon that when executed causes a computer to perform the computer implemented method according to claim 14.

17. A computer implemented method performed by a financial institution of a customer for authorizing a payment for a purchase by the customer from a merchant, the method comprising:
(a) receiving a message including a payment request from a central financial service (CFMS) having:
a customer identifier, and
purchase information;
(b) verifying the payment request;
(c) sending to the customer an authorization code to cause the customer to send to the merchant the authorization code;
(d) receiving a message including an authorization request from a CFMS including a further authorization code,
(e) determining whether the authorization code matches the further authorization code by comparing the authorization code with the further authorization code, and if so
(f) sending a message including an authorization confirmation to the CFMS to cause the CFMS to send a message including the authorization confirmation to the merchant FI.

18. A computer system a merchant of a financial institution of the merchant (merchant FI) for authorizing a payment for a purchase by a customer from the merchant, the system comprising:
one or more communications ports to send and receive messages; and
one or more processors to operate the communications port to:
(a) receive a message including a payment request from a central financial service (CFMS) having:
a customer identifier, and
purchase information;
(b) verify the payment request;
(c) send to the customer an authorization code to cause the customer to send to the merchant the authorization code;
(d) receive a message including an authorization request from a CFMS including a further authorization code,
(e) determine whether the authorization code matches the further authorization code by comparing the authorization code with the further authorization code, and if so
(f) send a message including an authorization confirmation to the CFMS to cause the CFMS to send a message including the authorization confirmation to the merchant FI.

19. A non-transitory computer readable medium with an executable program stored thereon that when executed causes a computer to perform the computer implemented method according to claim 17.
